(19) United States
(12) Patent Application Publication
(10) Pub. No.: US 2006/0148407 A1
(43) Pub. Date: Jul. 6, 2006

(54) Portable electronic device and battery module thereof

(75) Inventor: Yi-Kuan Lin, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/298,713

(22) Filed: Dec. 12, 2005

(30) Foreign Application Priority Data
Jan. 5, 2005 (TW) 094100299

(51) Int. Cl. H04B 7/00

(52) U.S. Cl. 455/66.1

(57) ABSTRACT

A portable electronic device includes a housing, an aroma unit and a heat source. In this case, the housing has an accommodating part. The aroma unit is placed in the accommodating part. The heat source is adjacent to the aroma unit. The heat source provides thermal energy and the aroma unit receives the thermal energy and spreads an aroma.

### BACKGROUND OF THE INVENTION

1. Field of the Invention

The invention relates to an electronic device and a battery module thereof, and more particularly to a portable electronic device and a battery module thereof.

2. Description of the Related Art

With the rapidly progress of electrical technology, various portable electronic devices have been developed and manufactured to bring humans a more convenient life. The portable electronic devices, such as mobile phones, notebook computers, digital audio players (MP3 players), and personal digital assistants (PDAs), have greatly enhanced the convenience and the work efficiency of modern life.

When the portable electronic device is not connected to any external power, an internal battery module has to be provided for a user to operate the portable electronic device. Thus, more and more users would like to use portable electronic devices with the battery module.

In order to attract consumers, manufacturers of the portable electronic devices have to do their best to design unique products. Most typical portable electronic devices drive consumers to purchase the product based on features such as light or sound effects. FIG. 1 is a schematic illustration showing a conventional portable electronic device 1. The portable electronic device 1, such as a mobile phone, has a housing 11 formed of a designed shape, and an external cover 13 of a battery 12 with a pattern 14 to catch the consumer's eye.

However, a portable electronic device using a sensuous smell to attract consumers has not been found. Thus, if the portable electronic device c an spread an aroma to be smelt by the user or other persons around the user, the user will smell stylish. In addition, the request for this personal feature for the user of the portable electronic device can be satisfied.

In view of the above-mentioned subject, the invention provides a portable electronic device and a battery module thereof capable of increasing a consumer's purchase desire by the sensuous smell.

### SUMMARY OF THE INVENTION

In view of the foregoing, the invention is to provide a portable electronic device and its battery module capable of spreading an aroma so as to enhance the consumer's purchase desire.

To achieve the above objective, an embodiment of the invention provides a portable electronic device including a housing, an aroma unit and a heat source. The housing has an accommodating space. An aroma medium is placed in the accommodating space. The heat source is adjacent to the aroma unit, and the aroma unit receives thermal energy from the heat source and spreads an aroma.

In another embodiment, the invention provides a battery module including a first cover, an aroma unit, a heat source, a second cover and a battery cell. The first cover defines a first accommodating space. The aroma unit is placed in the first accommodating space. The heat source, which is adjacent to the aroma unit, provides thermal energy. The aroma unit receives the thermal energy and spreads an aroma. The second cover is joined to the first cover so as to form a second accommodating space. The battery cell is placed in the second accommodating space.

In summary, the portable electronic device and its battery module according to embodiments of the invention can spread an aroma. Compared to the prior art, the heat source is placed adjacent to the aroma medium in the portable electronic device and its battery module. After the portable electronic device is turned on, the current of the portable electronic device flows into the heat source, or the electrical energy of the battery cell indirectly flows into the heat source of the battery module. Thus, the aroma substance in the aroma medium is spread into the air around the user due to the increase in the temperature of the heat source. The portable electronic device with the aroma and the battery module thereof not only spreads the comfortable aroma into the air around the user to enhance the atmosphere, but also represents the personal style of the user. Thus, the purchase desire of the consumer for the portable electronic device with battery module may be enhanced.

### BRIEF DESCRIPTION OF THE DRAWINGS

The invention will become more fully understood from the detailed description given herein below illustration only, and thus is not limiting the scope of the present invention, and wherein:

FIG. 1 is a schematic illustration showing a conventional portable electronic device;

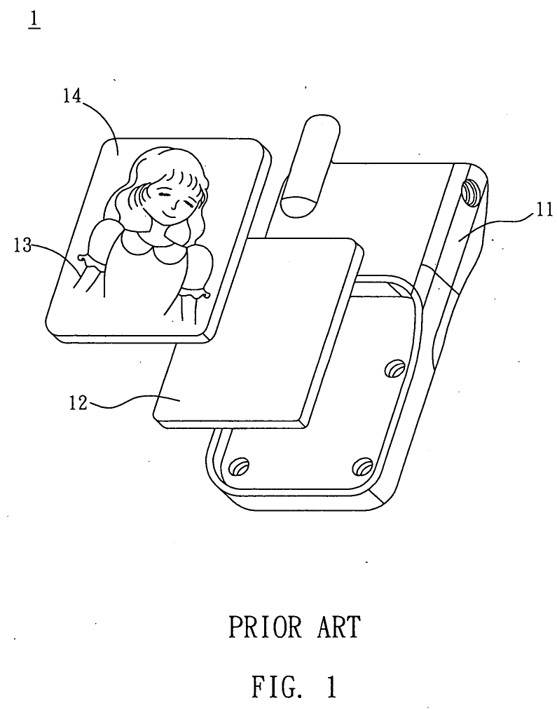

FIG. 2 is a schematic illustration showing a portable electronic device according to a preferred embodiment of the invention;

FIG. 3 is a schematic illustration showing an aroma unit combined with a heat source and a housing according to the preferred embodiment of the invention;

FIG. 4 is a schematic illustration showing a battery module according to another preferred embodiment of the invention; and

FIG. 5 is a schematic illustration showing an aroma unit combined with a heat source and a first cover according to another preferred embodiment of the invention.

### DETAILED DESCRIPTION OF THE INVENTION

The present invention will be apparent from the following detailed description, which proceeds with reference to the accompanying drawings, wherein the same references relate to the same elements.

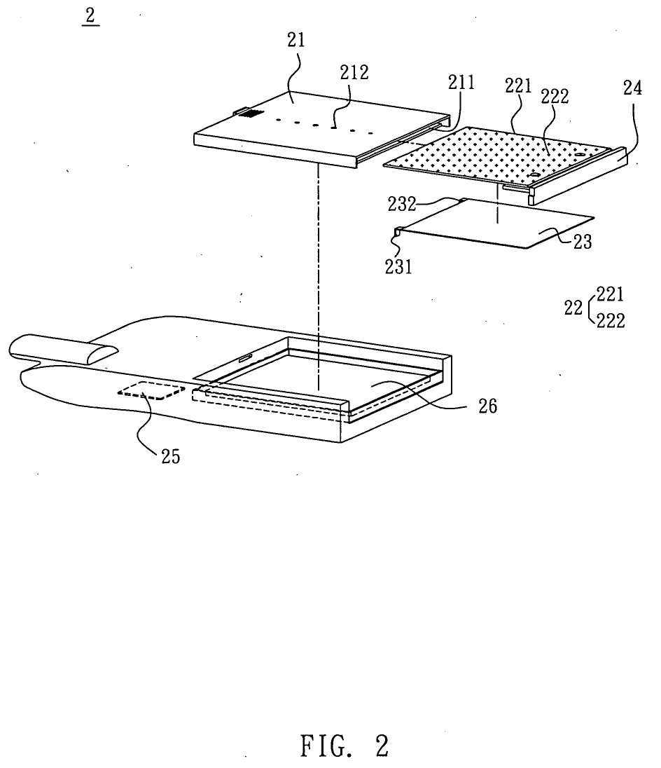

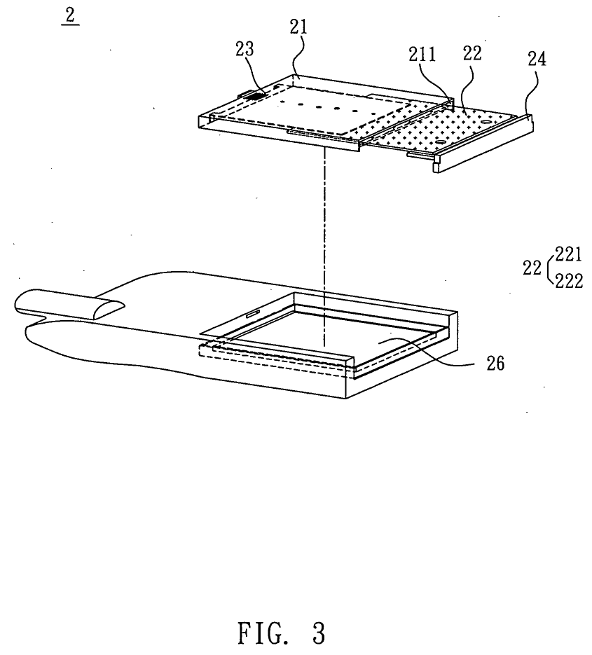

First, a portable electronic device according to a preferred embodiment of the invention will be described with reference to FIGS. 2 and 3.

FIG. 2 is a schematic illustration showing a portable electronic device according to the preferred embodiment of the invention. Referring to FIG. 2, the portable electronic device 2 includes a housing 21, an aroma unit 22 and a heat source 23. The portable electronic device 2 may be a mobile phone, a notebook computer, a personal digital assistant, or a digital audio player. In this embodiment, the portable electronic device 2 is a mobile phone.

The housing 21 has an accommodating space 211. In this embodiment, the housing 21 is an upper cover of a battery of the mobile phone. Of course, the housing 21 may also be the housing of other portions of the portable electronic device 2. In addition, the housing 21 has at least one through hole 212 for communicating the accommodating space 211 with the outside of the housing 21, so that the aroma spreads from the aroma unit 22 and can be dissipated to the outside.

As shown in FIG. 2 again, the aroma unit 22 is placed in the accommodating space 211. In this embodiment, the aroma unit 22 includes an aroma medium 221 and an aroma substance 222. The aroma medium 221, such as an absorptive plate, for absorbing the aroma substance 222 has a plurality of pores. In this embodiment, the aroma medium 221 may be a cotton board. The aroma substance 222 may be a perfume, an essence, a balm, an essential oil, or other substances capable of spreading the aroma. Because the aroma substance 222 is volatilized from the aroma unit 22 to the outside, the user can take out the aroma unit 22 and add a different aroma substance 222 according to the personal preference when the aroma substance 222 is exhausted.

In this embodiment, the portable electronic device 2 may include a handle 24 joined to the aroma unit 22. In this embodiment, the handle 24 may enclose the accommodating space 211 in conjunction with the housing 21. When the user wants to replace the aroma substance 222 or the aroma medium 221, he or she can pull the handle 24 and thus pull the aroma medium 221 out for performing the replacement operation.

FIG. 3 is a schematic illustration showing the aroma unit 22 combined with the heat source 23 and the housing 21 according to the preferred embodiment of the invention. As shown in FIG. 3, the heat source 23 adjacent to the aroma unit 22 provides thermal energy, and the aroma unit 22 receives the thermal energy and spreads an aroma.

As shown in FIG. 2 again, the heat source 23 of this embodiment is a thermocouple metal having a positive pole 231 and a negative pole 232. The portable electronic device 2 may further include a circuit board 25, and the positive pole 231 and the negative pole 232 are electrically connected to the circuit board 25. In addition, the portable electronic device 2 may further include a battery cell 26 electrically connected to the heat source 23. The battery cell 26 provides electrical energy to enable the heat source 23 to provide the thermal energy.

After the mobile phone is turned on, the electrical energy provided by the battery cell 26 may flow from the circuit board 25 to the heat source 23, and the temperature of the heat source 23 rises due to the thermocouple effect of the heat source 23. Consequently, the aroma unit 22 adjacent to the heat source 23 spreads the aroma substance 222 in the aroma unit 22 due to the increase of the temperature, and the aroma substance 222 is dissipated to the air around the user through the through hole 212 on the housing 21. The portable electronic device 2 having the aroma unit not only spreads the comfortable aroma into the air around the user, but also displays the personal style of the user. Thus, the purchase desire of the consumer on the portable electronic device 2 may be enhanced.

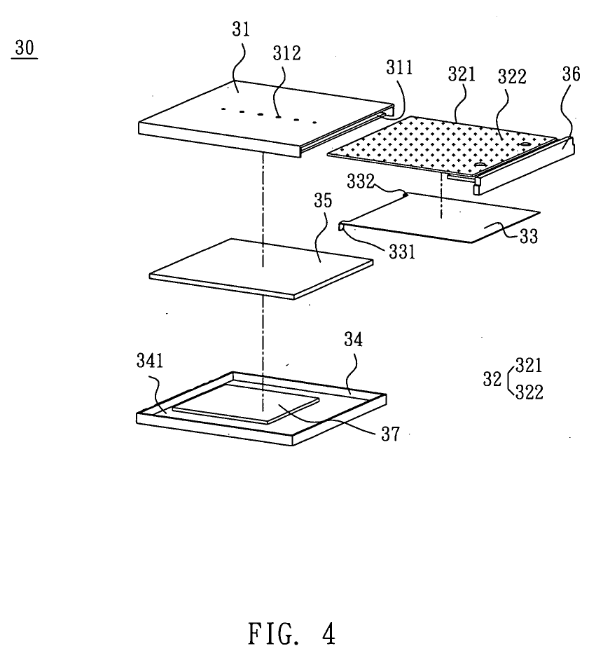

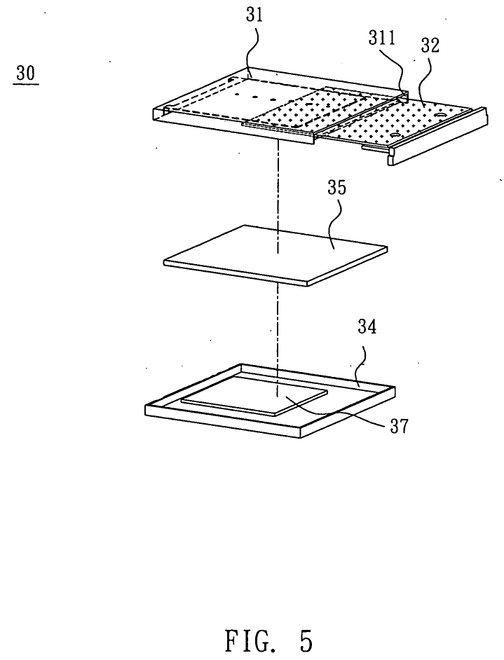

Next, a battery module according to another preferred embodiment of the invention will be described with reference to FIGS. 4 and 5.

FIG. 4 is a schematic illustration showing a battery module 30 according to another preferred embodiment of the invention. Referring to FIG. 4, the battery module 30 includes a first cover 31, an aroma unit 32, a heat source 33, a second cover 34 and a battery cell 35. In this embodiment, the battery module 30 may be used in a mobile phone, a notebook computer, a personal digital assistant, a digital audio player, or other portable electronic devices. In this embodiment, the battery module 30 is used in a mobile phone.

The first cover 31 defines a first accommodating space 311 for accommodating the aroma unit 32 and the heat source 33. In this embodiment, the first cover 31 has at least one through hole 312 that allows the aroma to spread from the aroma unit 32 and be dissipated to the outside.

As shown in FIG. 4 again, the aroma unit 32 is disposed in the first accommodating space 311. In this embodiment, the aroma unit 32 includes an aroma medium 321 and an aroma substance 322. The aroma medium 321 such as an absorptive plate for absorbing the aroma substance 322 has a plurality of pores. In this embodiment, for example, the aroma medium 321 is a cotton board. The aroma substance 322 may be a perfume, an essence, a balm, an essential oil, or other substances capable of spreading the aroma. Because the aroma substance 322 is disposed on the aroma medium 321 and volatilized to the outside, the user can take out the aroma medium 321 and add a different aroma substance 322 according to the personal preference when the aroma substance 322 is exhausted.

In this embodiment, the battery module 30 may further include a handle 36 joined to the aroma unit 32. In this embodiment, the handle 36 may enclose the first accommodating space 311 in conjunction with the first cover 31. When the user wants to replace the aroma substance 322 or the aroma medium 321, he or she can pull the handle 36 and thus pull the aroma medium 321 out for performing the replacement operation.

FIG. 5 is a schematic illustration showing the aroma unit 32 combined with the heat source 33 and the first cover 31 according to another preferred embodiment of the invention. The heat source 33 adjacent to the aroma unit 32 provides thermal energy, and the aroma unit 32 receives the thermal energy and spreads an aroma.

As shown in FIG. 4 again, the heat source 33 of this embodiment is a thermocouple metal having a positive pole 331 and a negative pole 332, both of which are electrically connected to the battery cell 35. The battery module 30 can introduce the electric power indirectly provided by the battery cell 35 into the heat source 33 through the positive pole 331 and the negative pole 332 so as to raise the temperature of the heat source 33. In addition, the battery module 30 of this embodiment may further include a circuit board 37 directly electrically connected to the positive pole 331 and the negative pole 332 of the thermocouple metal. Thus, the electric power provided by the battery cell 35 can be introduced into the heat source 33 through the circuit board 37 in order to raise the temperature of the heat source 33.

The second cover 34 is opposite to the first cover 31 to form a second accommodating space 341, in which the battery cell 35 is placed. In this embodiment, the battery cell 35 provides the electrical energy while the heat source 33 provides the thermal energy.

The battery module of the mobile phone will be described in an example. After the mobile phone is turned on, the electrical power provided by the battery cell 35 may flow to the heat source 33 through the circuit board 37 of the battery module 30, the positive pole 331 and the negative pole 332. The temperature of the heat source 33 rises due to the thermocouple effect of the heat source 33. Consequently, the aroma unit 32 adjacent to the heat source 33 spreads the aroma substance 322 absorbed in the aroma medium 321 due to the increase of the temperature, and the aroma substance 322 is dissipated into the air around the user through the through hole 312 in the first cover 31 at a side opposite to the second accommodating space 341. The battery module 30 having the aroma unit not only spreads the comfortable aroma into the air around the user, but also displays the personal style of the user. Thus, the purchase desire of the consumer on the battery module 30 may be enhanced.

In summary, the portable electronic device and its battery module according to the invention can spread the aroma. Compared to the prior art, the heat source is disposed adjacent to the aroma medium in the portable electronic device and its battery module according to the invention. After the portable electronic device is turned on, the current of the portable electronic device flows into the heat source, or the electrical energy of the battery cell indirectly flows into the heat source of the battery module. Thus, the aroma substance in the aroma medium is spread into the air around the user due to the increase in the temperature of the heat source. The portable electronic device with the aroma and the battery module thereof not only spread the comfortable aroma into the air around the user to ease the atmosphere, but also displays the personal style of the user. Thus, the purchase desire of the consumer on the portable electronic device and its battery module may be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A portable electronic device, comprising:
a housing, which has an accommodating space;
an aroma unit, which is placed in the accommodating space; and
a heat source, which is adjacent to the aroma unit for providing the aroma unit with a thermal energy, wherein the aroma unit spreads an aroma by the thermal energy.

2. The portable electronic device of claim 1, wherein the housing has at least one through hole for communicating the accommodating space with the outside.

3. The portable electronic device of claim 1, wherein the aroma unit comprises an aroma medium and an aroma substance.

4. The portable electronic device of claim 3, wherein the aroma medium has a plurality of pores for absorbing the aroma substance.

5. The portable electronic device of claim 3, wherein the aroma medium is an absorptive plate.

6. The portable electronic device of claim 3, wherein the aroma medium is a cotton board.

7. The portable electronic device of claim 3, wherein the aroma substance is a perfume, an essence, a balm, or an essential oil.

8. The portable electronic device of claim 1, further comprising:
a handle joined with the aroma unit, wherein at least a part of the handle remains outside of the accommodating space when the aroma unit is placed in the accommodating space.

9. The portable electronic device of claim 1, wherein the heat source is a thermocouple metal having a positive pole and a negative pole.

10. The portable electronic device of claim 1, further comprising:
a battery cell, which is electrically connected to the heat source, wherein the battery cell provides electrical energy to the heat source in order to make the heat source provide the thermal energy.

11. The portable electronic device of claim 10, wherein the heat source is a thermocouple metal having a positive pole and a negative pole, both of which are electrically connected to the battery cell.

12. The portable electronic device of claim 9, further comprising:
a circuit board, which is electrically connected to the positive pole and the negative pole of the thermocouple metal.

13. A battery module, comprising:
a first cover, which defines a first accommodating space;
an aroma unit, which is placed in the first accommodating space;
a heat source, which is adjacent to the aroma unit for providing the aroma unit with thermal energy, wherein the aroma unit spreads an aroma by the thermal energy;
a second cover, which is joined to the first cover so as to form a second accommodating space; and
a battery cell, which is placed in the second accommodating space.

14. The battery module of claim 13, wherein the first cover has at least one through hole formed on a side of the first cover not surrounding the second accommodating space.

15. The battery module of claim 13, wherein the aroma unit comprises an aroma medium and an aroma substance.

16. The battery module of claim 15, wherein the aroma medium has a plurality of pores for absorbing the aroma substance.

17. The battery module of claim 15, wherein the aroma medium is an absorptive plate.

18. The battery module of claim 15, wherein the aroma medium is a cotton board.

19. The battery module of claim 15, wherein the aroma substance is a perfume, an essence, a balm, or an essential oil.

20. The battery module of claim 13, further comprising:
a handle, which is joined with the aroma unit.

21. The battery module of claim 13, wherein the heat source is a thermocouple metal having a positive pole and a negative pole.

22. The battery module of claim 21, wherein the positive pole and the negative pole of the thermocouple metal are electrically connected to the battery cell.

23. The battery module of claim 13, wherein the heat source is electrically connected to the battery cell, which provides electrical energy to make the heat source provide the thermal energy.

24. The battery module of claim 21, further comprising:
a circuit board, which transferres electrical energy of the battery cell, wherein the positive pole and the negative pole of the thermocouple metal are electrically connected to the circuit board.
